(19) United States
(12) Patent Application Publication
(10) Pub. No.: US 2009/0319269 A1
(43) Pub. Date: Dec. 24, 2009

(54) Method of Trainable Speaker Diarization

(76) Inventor: Hagai Aronowitz, Petah-Tikva (IL)

Correspondence Address: IBM CORPORATION, T.J. WATSON RESEARCH CENTER, P.O. BOX 218, YORKTOWN HEIGHTS, NY, 10598, US

(21) Appl. No.: 12/144,659

(22) Filed: Jun. 24, 2008

(51) Int. Cl. H04M 3/00

(52) U.S. Cl. 704/243

(57) ABSTRACT

A novel and useful method of using labeled training data and machine learning tools to train a speaker diarization system. Intra-speaker variability profiles are created from training data consisting of an audio stream labeled where speaker changes occur (i.e. which participant is speaking at any given time). These intra-speaker variability profiles are then applied to an unlabeled audio stream to segment the audio stream into speaker homogeneous segments and to cluster segments according to speaker identity.

### FIELD OF THE INVENTION

The present invention relates to the field of speaker diarization, and more particularly relates to a method of using labeled training data to train a speaker diarization system.

### SUMMARY OF THE INVENTION

There is thus provided in accordance with the invention, a method of segmenting an audio stream into speaker homogenous segments, the method comprising the steps of creating a plurality of intra-speaker variability profiles from training data and analyzing said audio stream using said intra-speaker variability profiles, thereby marking speaker homogeneous segments within said audio stream.

There is also provided a accordance of the invention, a method of modeling intra speaker variability in an audio stream, the method comprising the steps of segmenting said audio stream into a plurality of evenly spaced segments, associating each said evenly spaced segment with a particular speaker identity; calculating a score representing the similarity between adjacent evenly spaced segments associated with the same speaker identity and clustering said scores, thereby creating a intra-speaker variability profile for each said speaker identity.

There is further provided a computer program product for segmenting an audio stream into speaker homogenous segments, the computer program product comprising a computer usable medium having computer usable code embodied therewith, the computer program product comprising computer usable code configured for creating a plurality of intra-speaker variability profiles from training data and computer usable code configured for analyzing said audio stream using said intra-speaker variability profiles, thereby marking speaker homogeneous segments within said audio stream.

### BRIEF DESCRIPTION OF THE DRAWINGS

The invention is herein described, by way of example only, with reference to the accompanying drawings, wherein:

FIG. 1 is a block diagram illustrating an example computer processing system adapted to implement the speaker trainable diarization method of the present invention;

FIG. 2 is a block diagram illustrating an example system implementing the intra-speaker variability profile creation method of the present invention;

FIG. 3 is a block diagram illustrating an example system implementing the speaker diarization method of the present invention;

FIG. 4 is a block diagram illustrating the intra-speaker variability profile creation method of the present invention; and

FIG. 5 is a flow diagram illustrating the speaker diarization method of the present invention.

### DETAILED DESCRIPTION OF THE INVENTION

### Notation Used Throughout

The following notation is used throughout this document:

| Term | Definition |
|---|---|
| ASIC | Application Specific Integrated Circuit |
| CD-ROM | Compact Disc Read Only Memory |
| CPU | Central Processing Unit |
| DSP | Digital Signal Processor |
| EEROM | Electrically Erasable Read Only Memory |
| EPROM | Erasable Programmable Read-Only Memory |
| FPGA | Field Programmable Gate Array |
| FTP | File Transfer Protocol |
| GMM | Gaussian Mixture Model |
| HTTP | Hyper-Text Transport Protocol |
| I/O | Input/Output |
| LAN | Local Area Network |
| MAP | maximum posteriori |
| NIC | Network Interface Card |
| PCA | principal component analysis |
| RAM | Random Access Memory |
| RF | Radio Frequency |
| ROM | Read Only Memory |
| UBF | universal background model |
| WAN | Wide Area Network |
| w.r.t. | with respect to |

### DETAILED DESCRIPTION OF THE INVENTION

The present invention is a method of using labeled training data and machine learning tools to train a speaker diarization system. Intra-speaker variability profiles are created from training data consisting of an audio stream labeled where speaker changes occur (i.e. which participant is speaking at any given time). These intra-speaker variability profiles are then applied to an (unlabeled) audio stream to cluster the audio stream into speaker homogeneous segments and to combine adjacent segments according to speaker identity.

One example application of the invention is to facilitate the development of tools to segment unlabeled audio streams into speaker homogeneous segments. Automated segmentation of audio stream helps optimize performance and accuracy of speech and speaker recognition systems.

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

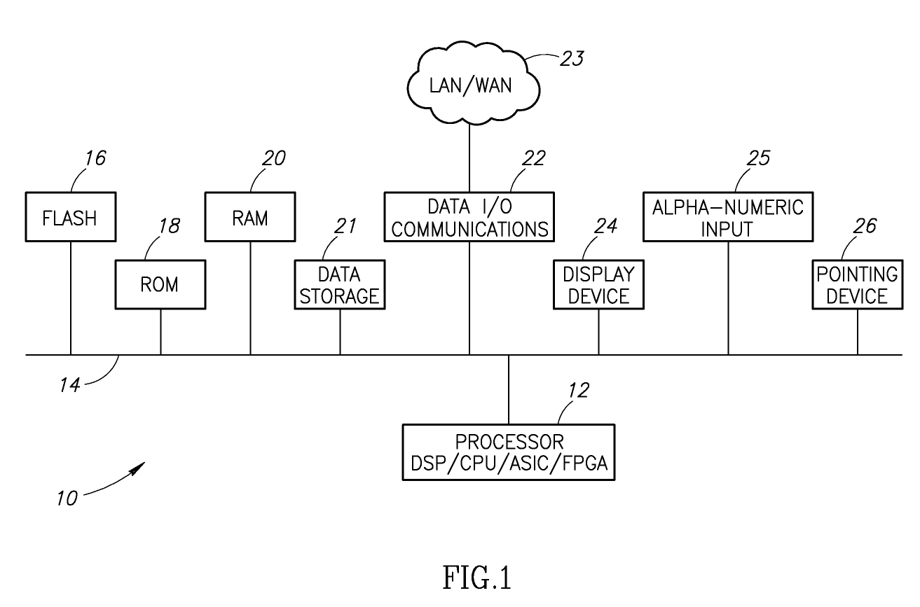

A block diagram illustrating an example computer processing system adapted to implement the trainable speaker diarization method of the present invention is shown in FIG. 1. The computer system, generally referenced 10, comprises a processor 12 which may comprise a digital signal processor (DSP), central processing unit (CPU), microcontroller, microprocessor, microcomputer, ASIC or FPGA core. The system also comprises static read only memory 18 and dynamic main memory 20 all in communication with the processor. The processor is also in communication, via bus 14, with a number of peripheral devices that are also included in the computer system. Peripheral devices coupled to the bus include a display device 24 (e.g., monitor), alpha-numeric input device 25 (e.g., keyboard) and pointing device 26 (e.g., mouse, tablet, etc.)

The computer system is connected to one or more external networks such as a LAN or WAN 23 via communication lines connected to the system via data I/O communications interface 22 (e.g., network interface card or NIC). The network adapters 22 coupled to the system enable the data processing system to become coupled to other data processing systems or remote printers or storage devices through intervening private or public networks. Modems, cable modem and Ethernet cards are just a few of the currently available types of network adapters. The system also comprises magnetic or semiconductor based storage device 52 for storing application programs and data. The system comprises computer readable storage medium that may include any suitable memory means, including but not limited to, magnetic storage, optical storage, semiconductor volatile or non-volatile memory, biological memory devices, or any other memory storage device.

Software adapted to implement the trainable speaker diarization method of the present invention is adapted to reside on a computer readable medium, such as a magnetic disk within a disk drive unit. Alternatively, the computer readable medium may comprise a floppy disk, removable hard disk, Flash memory 16, EEROM based memory, bubble memory storage, ROM storage, distribution media, intermediate storage media, execution memory of a computer, and any other medium or device capable of storing for later reading by a computer a computer program implementing the method of this invention. The software adapted to implement the trainable speaker diarization method of the present invention may also reside, in whole or in part, in the static or dynamic main memories or in firmware within the processor of the computer system (i.e. within microcontroller, microprocessor or microcomputer internal memory).

Other digital computer system configurations can also be employed to implement the complex event processing system rule generation mechanism of the present invention, and to the extent that a particular system configuration is capable of implementing the system and methods of this invention, it is equivalent to the representative digital computer system of FIG. 1 and within the spirit and scope of this invention.

Once they are programmed to perform particular functions pursuant to instructions from program software that implements the system and methods of this invention, such digital computer systems in effect become special purpose computers particular to the method of this invention. The techniques necessary for this are well-known to those skilled in the art of computer systems.

It is noted that computer programs implementing the system and methods of this invention will commonly be distributed to users on a distribution medium such as floppy disk or CD-ROM or may be downloaded over a network such as the Internet using FTP, HTTP, or other suitable protocols. From there, they will often be copied to a hard disk or a similar intermediate storage medium. When the programs are to be run, they will be loaded either from their distribution medium or their intermediate storage medium into the execution memory of the computer, configuring the computer to act in accordance with the method of this invention. All these operations are well-known to those skilled in the art of computer systems.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

### Trainable Speaker Diarization

In accordance with the invention, intra-speaker variability profiles are first created from training data comprising an audio stream labeled where each participant is speaking. The intra-speaker variability profiles are then applied to an unlabeled audio stream. Analysis of the unlabeled audio stream (using the intra-speaker variability profiles) segments the audio stream into speaker homogeneous segments.

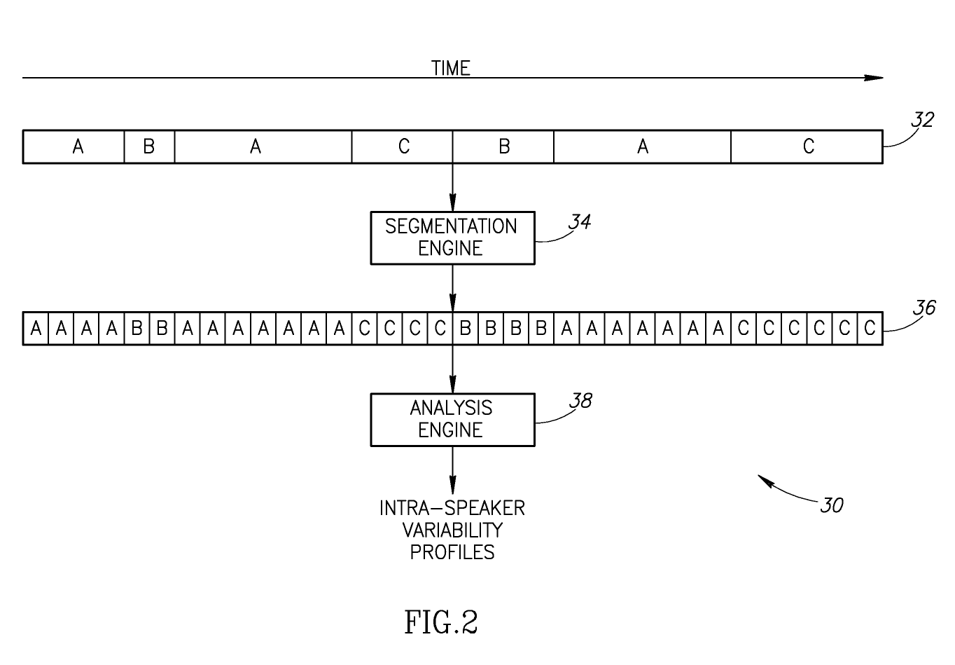

A block diagram illustrating an example implementation of the intra-speaker variability profile creation method of the present invention is shown in FIG. 2. The analysis block diagram, generally referenced 30, comprises audio streams 32 and 36, segmentation engine 34 and analysis engine 38. In operation, the user provides audio stream 32 which is segmented by speaker identity (in this case, speakers A, B and C). Segmentation engine 34 further partitions the audio stream into smaller evenly spaced segments, producing audio stream 36. Audio stream 36 comprises smaller segments, with each segment labeled as to its speaker. Audio stream 36 is then input into analysis engine 38, which generates the appropriate intra-speaker variability profiles.

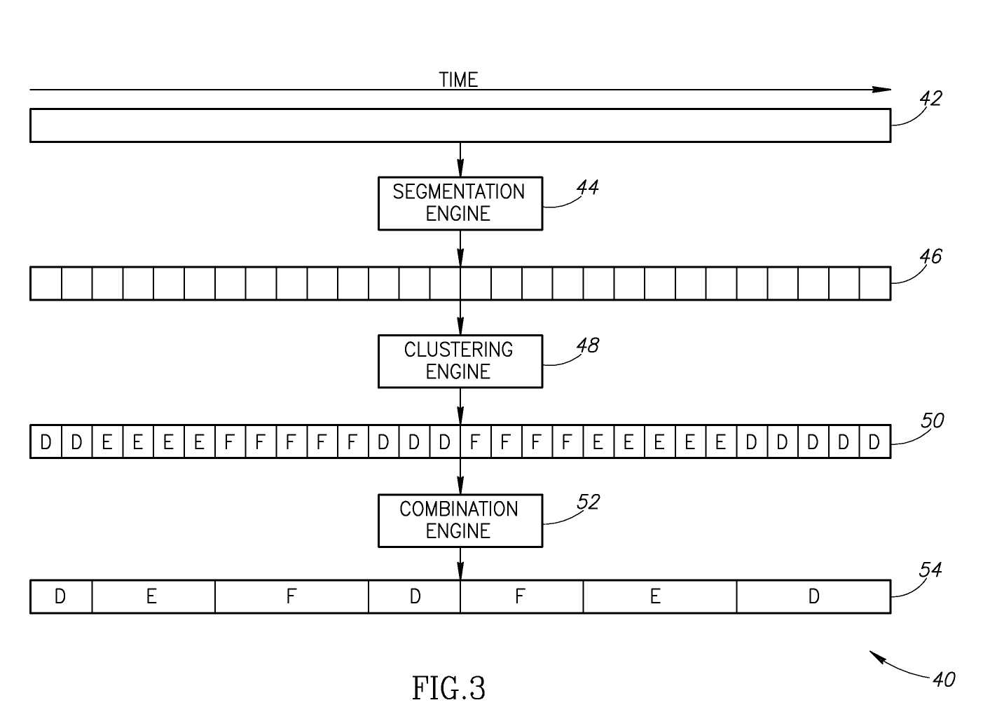

A block diagram illustrating an example implementation of the speaker diarization method of the present invention is shown in FIG. 3. The analysis block diagram, generally referenced 40, comprises audio streams 42, 46, 50, segmentation engine 44, clustering engine 48 and combination engine 52. In operation, the user provides unlabeled audio stream 42 as an input to segmentation engine 44. Segmentation engine 44 partitions the audio stream into smaller (still unlabeled) evenly spaced segments, producing audio stream 46. Audio stream 46 is then input to clustering engine 48, which clusters the evenly spaced segments by means of an algorithm using the intra-speaker variability profiles which are defined by the training data. The clustering engine labels each evenly spaced segment with a speaker identity (in this example D, E and F), producing labeled audio stream 52. Audio stream 52 is then input to combination engine 54 which combines adjacent evenly spaced segments associated with the same participant, producing labeled audio stream 54.

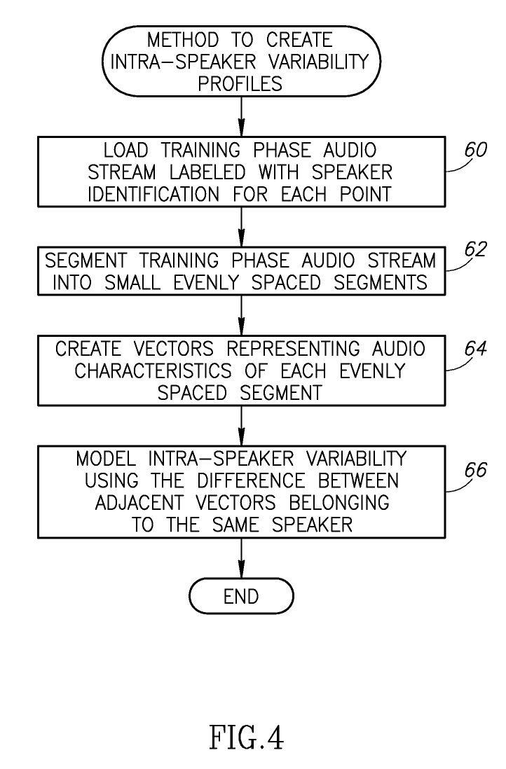

A flow diagram illustrating the intra-speaker variability profile creation method of the present invention is shown in FIG. 4. First, an audio stream labeled as to speaker identification (at each point of the audio stream) is loaded (step 60). The labeled audio stream is then segmented into smaller evenly spaced segments (step 62) and a vector representing audio characteristics of each evenly spaced segment is created (step 64). Typically, a Gaussian Mixture Model (GMM) is used to create the vector. Finally, intra-speaker variability is modeled using the difference between adjacent vectors belonging to the same speaker (step 66).

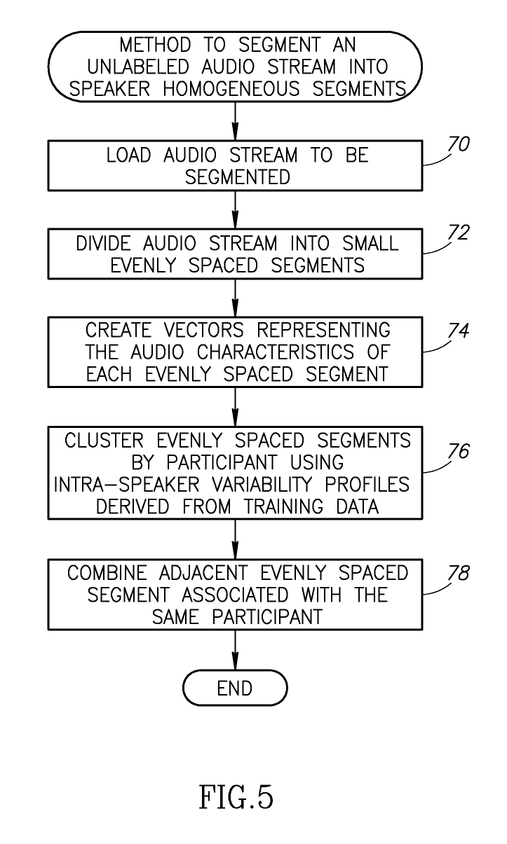

A flow diagram illustrating the speaker diarization of the present invention is shown in FIG. 5. First an unlabeled (i.e. as to participants) audio stream is loaded (step 70). The audio stream is then divided into smaller evenly spaced segments (step 72), and a vector representing audio characteristics of each evenly spaced segment is created (step 74). Typically, a Gaussian Mixture Model (GMM) is used to create the vector. The vectors are then clustered via the intra-speaker variability profiles defined in the training data (step 76), thereby associating each evenly spaced segment with a particular participant (i.e. speaker). Finally, adjacent segments associated with the same participant are then combined, (step 78), thereby creating an audio stream labeled with the location of the participation of each speaker.

### Kernel Principal Component Analysis

In one embodiment of the present invention, kernel principal component analysis (PCA) is a method used to create the intra-speaker variability profiles from the training data (i.e. the labeled audio stream) and to define the speaker homogeneous segments in the test data (i.e., the unlabeled audio stream). Kernel-PCA is a kernelized version of the PCA algorithm. Function K(x,y) is a kernel if there exists a dot product space F (named “feature space”) and a mapping f:V→F from observation space V (named ‘input space’) for which:

∀x,yεV K(x,y)= [symbol] (f(x),f(y) [symbol] (1)

Given a set of reference vectors A₁, . . . , Aₙ in V, the kernel-matrix K is defined as K_{i,j}=K(Aᵢ, Aⱼ). The goal of kernel-PCA is to find an orthonormal basis for the subspace spanned by the set of mapped reference vectors f(A₁), . . . , f(Aₙ). The outline of the kernel-PCA algorithm is as follows:
1) Compute a centralized kernel matrix \tilde{K}:

\tilde{K}=K−1ₙK−K1ₙ+1ₙK1ₙ (2)
where 1ₙ is an n×n matrix with all values set to one.
2) Compute eigenvalues λ₁, . . . , λₙ and corresponding eigenvectors v₁, . . . , vₙ for matrix \tilde{K}.
3) Normalize each eigenvector by the square root of its corresponding eigenvalue (for the non-zero eigenvalues λ₁, . . . , λₘ).

\tilde{v}ᵢ=vᵢ/\sqrt{λᵢ}, I={1, . . . , m} (3)

The i^{th} eigenvector in feature space denoted by fᵢ is:

fᵢ=(f(A₁), . . . , f(Aₙ))\tilde{v}ᵢ (4)

The set of eigenvectors {f₁, . . . , fₘ} is an orthonormal basis for the subspace spanned by {f(A₁), . . . , f(Aₙ)}.

Let x be a vector in input space V with a projection in feature space denoted by f(x), f(x) can be uniquely expressed as a linear combination of basis vectors {fᵢ(x)} with coefficients {αᵢ^{x}}, and a vector uₓ in V/span {f₁, . . . , fₘ} which is the complementary subspace of span {f₁, . . . , fₘ}.

$$f ( x ) = {\sum }_{i = 1}^{m} {α}_{i}^{x} {f}_{i} + {u}_{x} \qquad ( 5 )$$

Note that αᵢ^{x}= [symbol] f(x),fᵢ [symbol] . Using equations (1) and (4), αᵢ^{x} can be expressed as:

αᵢ^{x}=(K(x,A₁), . . . , K(x,Aₙ))\tilde{v}ᵢ (6)

We define a projection T:V→R^{m} as:

T(x)=(\tilde{v}₁, . . . , \tilde{v}ₘ)^{T}(K(x,A₁), . . . , K(x,Aₙ))^{T} (7)

The following property holds for projection T:

$$if f ( x ) = {\sum }_{i = 1}^{m} {α}_{i}^{x} {f}_{i} + {u}_{x} and f ( y ) = {\sum }_{i = 1}^{m} {α}_{i}^{y} {f}_{i} + {u}_{y} then \text{:} \\ {‖ f ( x ) - f ( y ) ‖}^{2} = {‖ T ( x ) - T ( y ) ‖}^{2} + {‖ {u}_{x} - {u}_{y} ‖}^{2} \qquad ( 8 )$$

Equation (8) implies that projection T preserves distances in the feature subspace spanned by {f(A₁), . . . , f(Aₙ)}.

### Kernel-PCA for Speaker Diarization

Given a set of sequences of frames corresponding to speaker homogeneous segments, it is desirable to project them into a space where speaker variation can naturally be modeled, while still preserving relevant information. Relevant information is defined in this paper as distances in feature space F defined by a kernel function. Equation (7) suggests such a projection. Using projection T as the chosen projection has the advantage of having R^{m} as a natural target space for modeling. Equation (8) quantifies the amount distances are distorted by projection T. In order to capture some of the information lost by projection T we define a second projection:

U(x)=uₓ (9)

Although we cannot explicitly apply projection U, we can easily calculate the distance between two vectors uₓ and u_{y} using the distance between x and y in feature space F and their distance after projection with T.

∥U(x)−U(y)∥²=∥f(x)−f(y)∥²−∥T(x)−T(y)∥² (10)

Using both projections T and U enables capturing the relevant information. The subspace spanned by {f(A₁), . . . , f(Aₙ)} is named the common-speaker subspace, as attributes that are common to several speakers will typically be projected into it. The complementary space is named the speaker-unique space, as attributes that are unique to a speaker will typically be projected to that subspace.

The next step is modeling in common speaker subspace. The purpose of the projection of the common-speaker subspace into R^{m} using projection T is to enable modeling of inter-segment speaker variability. Inter-segment speaker variability is closely related to intersession variability modeling which has proven to be extremely successful for speaker recognition. We model speakers' distributions in common-speaker subspace as multivariate normal distributions with a shared full covariance matrix S which is m×m dimensional (m is the dimension of the common-speaker space).

Given an annotated training dataset, we extract non-overlapping speaker homogeneous segments (of fixed length). Given speakers s₁, . . . , sₖ with n(sᵢ) segments for speaker sᵢ, T(xₛ_{ᵢ},1), . . . , T(xₛ_{ᵢ}, n(sᵢ)) denotes the n(sᵢ) segments of speaker sᵢ projected into common-speaker subspace. We estimate S as

$$Σ = \frac{1}{{\sum }_{i} n ( {s}_{i} )} {\sum }_{i} {\sum }_{j = 1}^{n ( {s}_{i} )} ( T ( {x}_{{s}_{i}} , j ) - {μ}_{{s}_{i}} ) {( T ( {x}_{{s}_{i}} , j ) - {μ}_{{s}_{i}} )}^{T} \qquad ( 11 )$$

where μₛ_{ᵢ} denotes the mean of the distribution of speaker sᵢ and is estimated as

$${μ}_{{s}_{i}} = \frac{1}{n ( {s}_{i} )} {\sum }_{j = 1}^{n ( {s}_{i} )} T ( {x}_{{s}_{i}} , j ) \qquad ( 12 )$$

We regularize S by adding a positive noise component η to the elements of its diagonal

\tilde{Σ}=Σ+ηI (13)

The resulting covariance matrix is guaranteed to have eigenvalues greater than η, therefore it is invertible.

Given a pair of segments x and y projected into common-speaker subspace (T(x) and T(y) respectively), the likelihood of T(y) conditioned on T(x) and assuming x and y share the same speaker identity is

$$Pr ( T ( y ) \vert T ( x ) , x \sim y ) = \frac{1}{{( 2 π )}^{\frac{m}{2}} {\vert 2 \tilde{Σ} \vert}^{\frac{1}{2}}} {e}^{- \frac{{( T ( y ) - T ( x ) )}^{T} {( 2 \tilde{Σ} )}^{- 1} ( T ( y ) - T ( x ) )}{2}} \qquad ( 14 )$$

where 2\tilde{Σ} is the covariance matrix of the random variable T(y)−T(x).

For the sake of efficiency, diagonalize the covariance matrix 2\tilde{Σ} by computing its eigenvectors {eᵢ} and eigenvalues {íᵢ}. Defining E as e₁^{T}, . . . , eₘ^{T}), equation (14) reduces to:

$$Pr ( T ( y ) \vert T ( x ) , x \sim y ) = \frac{1}{{( 2 π )}^{\frac{m}{2}} {\prod }_{i = 1}^{m} \sqrt{{β}_{i}}} {e}^{- {\sum }_{i = 1}^{m} \frac{{[ \tilde{T} ( y ) - \tilde{T} ( x ) ]}_{i}^{2}}{2 {β}_{i}}} \qquad ( 15 )$$

where \tilde{T}(x)=E·T(x), \tilde{T}(y)=E·T(y) and [x]ᵢ is the i^{th} coefficient of x.

There is also modeling in speaker unique subspace. Δ_{u(x,y)}² denotes the squared distance between segments x and y projected into the speaker unique subspace. We assume

$$Pr ( {Δ}_{u ( x , y )}^{2} \vert x \sim y ) = \frac{1}{\sqrt{2 π} {σ}_{u}} {e}^{- \frac{{Δ}_{u}^{2} ( x , y )}{2 {σ}_{u}^{2}}} \qquad ( 16 )$$

and estimate sᵤ from the development data.

When modeling in segment space, the likelihood of segment y given segment x and given the assumption that both segments share the same speaker identity is

Pr(y|x,x˜y)=Pr(T(y)|T(x),x˜y)Pr(Δ_{u(x,y)}²|x˜y) (17)

The expression in equation (17) can be calculated using equations (15) and (16).

To normalize scores, the speaker similarity score between segments x and y is defined as log(Pr(y|x,x˜y). Score normalization is a standard and extremely effective method in speaker recognition. We use T-norm (4) and TZ-norm (2) for score normalization in the context of speaker diarization. Given held out segments t₁, . . . , t_{T} from a development set, The T-normalized score (S(x,y)) of segment y given segment x is:

$$S ( x , y ) = \frac{log ( Pr ( y \vert x , x \sim y ) ) - {mean}_{i} ( log ( Pr ( y \vert {t}_{i} , {t}_{i} \sim y ) ) )}{\sqrt{{var}_{i} ( log ( Pr ( y \vert {t}_{i} , {t}_{i} \sim y ) ) )}} . \qquad ( 18 )$$

The TZ-normalized score of segment y given segment x is calculated similarly according to equation (10).

Finally, kernels for speaker diarization are defined. In equation (5) it was shown that under reasonable assumptions a GMM trained on a test utterance is as appropriate for representing the utterance as the actual test frames (the GMM is approximately a sufficient statistic for the test utterance w.r.t. GMM scoring). Therefore the kernels used are based on GMM parameters trained for the scored segments. GMMs are maximum-posteriori (MAP) adapted from a universal background model (UBM) of order 1024 with diagonal covariance matrices.

The kernel described supra was inspired by equation (14). The kernel is based on the weighted-normalized GMM means:

$$K ( x , y ) = {\sum }_{g = 1}^{G} {w}_{g}^{UBM} {\sum }_{d = 1}^{D} \frac{{μ}_{g , d}^{x} {μ}_{g , d}^{y}}{2 {( {σ}_{g , d}^{UBM} )}^{2}} \qquad ( 19 )$$

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of segmenting an input audio stream into speaker homogenous segments, said method comprising the steps of:
creating a plurality of intra-speaker variability profiles from training data; and
analyzing said input audio stream using said intra-speaker variability profiles and marking speaker homogeneous segments therein.

2. The method according to claim 1, wherein said training data comprises an audio recording with a plurality of participants.

3. The method according to claim 1, wherein the number of participants in said training data is known.

4. The method according to claim 1, wherein said training data is labeled to indicate which said participant is speaking at any point in said training data.

5. The method according to claim 1, wherein said step of creating a plurality of intra-speaker profiles from training data comprises the steps of:
segmenting said training data into a plurality of evenly spaced segments;
associating each said evenly spaced segment with a particular speaker identity;
calculating a score representing the similarity between adjacent said evenly spaced segments associated with a particular speaker identity; and
clustering said scores to create a intra-speaker variability profile for each said speaker identity.

6. The method according to claim 1, wherein said audio stream comprises an audio recording with a plurality of participants.

7. The method according to claim 1, wherein the number of participants in said audio stream is not known.

8. The method according to claim 1, wherein said step of analyzing said audio stream using said intra-speaker variability profiles comprises the steps of:
segmenting said audio stream into a plurality of evenly spaced segments;
calculating a score representing the features of each said evenly spaced segment; and
clustering said scores using said intra-speaker variability profiles derived from said training data.

9. A method of modeling intra speaker variability in an audio stream, said method comprising the steps of:
segmenting said audio stream into a plurality of evenly spaced segments;
associating each said evenly spaced segment with a particular speaker identity;
calculating a plurality of scores wherein each score represents the similarity between adjacent evenly spaced segments associated with the same speaker identity; and
clustering said plurality of scores to create a intra-speaker variability profile for each said speaker identity.

10. The method according to claim 9, wherein said audio stream comprises an audio recording with a plurality of participants.

11. The method according to claim 9, wherein the number of participants in said audio stream is known.

12. The method according to claim 9, wherein said audio stream is labeled to indicate which said participant is speaking at any point in said audio stream.

13. A computer program product for segmenting an audio stream into speaker homogenous segments, the computer program product comprising:
a computer usable medium having computer usable code embodied therewith, the computer program product comprising:
computer usable code configured for creating a plurality of intra-speaker variability profiles from training data; and
computer usable code configured for analyzing said audio stream using said intra-speaker variability profiles, thereby marking speaker homogeneous segments within said audio stream.

14. The computer program product according to claim 13, wherein said training data comprises an audio recording with a plurality of participants.

15. The computer program product according to claim 13, wherein the number of participants in said training data is known.

16. The computer program product according to claim 13, wherein said training data is labeled to indicate which said participant is speaking at any point in said training data.

17. The computer program product according to claim 13, wherein said step of creating a plurality of intra-speaker profiles from training data comprises the steps of:
segmenting said training data into a plurality of evenly spaced segments;
associating each said evenly spaced segment with a particular speaker identity;
calculating a score representing the similarity between adjacent said evenly spaced segments associated with a particular speaker identity; and
clustering said scores to create a intra-speaker variability profile for each said speaker identity.

18. The computer program product according to claim 13, wherein said audio stream comprises an audio recording with a plurality of participants.

19. The computer program product according to claim 13, wherein the number of participants in said audio stream is not known.

20. The computer program product according to claim 13, wherein said step of analyzing said audio stream using said intra-speaker variability profiles comprises the steps of:
segmenting said audio stream into a plurality of evenly spaced segments;
calculating a score representing the features of each said evenly spaced segment; and
clustering said scores using said intra-speaker variability profiles derived from said training data.
